(19) United States
(12) Patent Application Publication
(10) Pub. No.: US 2025/0337658 A1
(43) Pub. Date: Oct. 30, 2025

(54) JAMMING DETECTION AND MITIGATION METHODS FOR LOW POWERED WIDE AREA NETWORKS

(71) Applicant: MORGAN STATE UNIVERSITY, Baltimore, MD (US)

(72) Inventors: Kevin Kornegay, Towson, MD (US); Sean Richardson, Elkridge, MD (US)

(21) Appl. No.: 19/193,173

(22) Filed: Apr. 29, 2025

Related U.S. Application Data
(60) Provisional application No. 63/640,039, filed on Apr. 29, 2024.

(51) Int. Cl. H04L 41/16; H04L 41/0816; H04W 28/02; H04W 84/18

(52) U.S. Cl. CPC H04L 41/16; H04L 41/0816; H04W 28/0236; H04W 84/18

(57) ABSTRACT

A system and method for detecting and mitigating jamming attacks in low-power wide-area networks (LPWAN) uses machine learning techniques. The system collects network performance data including packet loss ratios and received signal strength indicators from LoRaWAN sensor nodes. A Long Short-Term Memory (LSTM) neural network analyzes temporal patterns in the data to distinguish malicious jamming from normal network congestion. Upon detecting jamming conditions, the system implements automated mitigation through a cloud-based framework that coordinates random channel selection and network reconfiguration. The system leverages LoRaWAN's inherent “Capture Effect” characteristics while providing additional protection through dynamic frequency adjustment. Performance metrics demonstrate 98% accuracy in jamming detection with a 0.5% false positive rate. The architecture enables continuous monitoring and automated response to maintain network integrity while preserving the power efficiency benefits of LPWAN systems.

### CROSS-REFERENCE TO RELATED APPLICATIONS

This application claims priority to U.S. Provisional Application No. 63/640,039, filed Apr. 29, 2024, entitled “Jamming Detection and Mitigation Methods for Low Powered Wide Area Networks,” the specification of which is hereby incorporated by reference in its entirety.

### FIELD OF THE INVENTION

This invention relates generally to wireless communications systems, and more particularly to detection and mitigation of jamming attacks in low-power wide-area networks (LPWAN).

### BACKGROUND OF THE INVENTION

LPWANs have become increasingly critical for Internet of Things (IoT) applications including smart cities, agriculture, utilities, and sensor networks. These networks offer distinct advantages including long range, small data payload size, low cost, and extended battery life compared to alternative wireless technologies.

LoRaWAN, a prominent LPWAN technology, operates in sub-GHz industrial and medical (ISM) bands using Chirp Spread Spectrum (CSS) modulation. The technology combines LoRa physical layer modulation with the LoRaWAN network protocol to enable low-power, high radio budget communications.

While LoRaWAN implements security measures through upper-level symmetric-key encryption using the AES-128 algorithm, it remains vulnerable to attacks at lower protocol levels, particularly the MAC and physical layers. For network operators, a key technical challenge involves distinguishing between packet loss caused by regular network congestion versus malicious jamming activities. This challenge is compounded by LoRaWAN's use of an Aloha protocol that transmits without first sensing the channel, as well as the random transmission patterns typical in unlicensed ISM bands.

Existing approaches to jamming detection and mitigation face several technical limitations. Current solutions often rely on basic signal strength thresholds or simple alarm mechanisms. While these approaches can detect basic interference, they struggle to differentiate sophisticated jamming attacks from normal network operation conditions.

Some prior systems have explored distributed communication architectures incorporating blockchain technology to address jamming concerns. However, these solutions can introduce additional complexity and overhead that may not be suitable for low-power applications. Other approaches have investigated sensor fingerprinting techniques for device identification, but these methods may not fully address coordinated jamming attacks across multiple network nodes.

Recent developments in wireless network security have begun incorporating artificial intelligence and machine learning techniques to enable more sophisticated monitoring and response capabilities. However, implementing such approaches while maintaining the power efficiency benefits of LPWAN systems remains an ongoing challenge in the field.

The “Capture Effect” phenomenon in LoRaWAN provides some natural resistance to interference, as packets with signal strength differences greater than 6 dB can still be successfully received despite collisions. However, this mechanism alone is insufficient protection against dedicated jamming attacks.

Thus, there remains a need in the art for systems and methods that can effectively distinguish between malicious jamming attacks and normal network congestion in LPWAN environments while maintaining low power operation. Prior approaches using basic signal strength thresholds or blockchain-based solutions have not adequately addressed the challenges of protecting critical sensor networks without introducing significant computational overhead. Additionally, existing systems lack the ability to automatically mitigate detected jamming through dynamic frequency adjustment while preserving the power efficiency benefits that make LPWAN technology valuable for IoT applications. A solution is needed that can leverage machine learning techniques to achieve high detection accuracy with low false positive rates, while implementing automated mitigation responses that maintain network continuity across diverse industrial deployments.

### SUMMARY OF THE INVENTION

In accordance with certain aspects of an embodiment of the invention, systems and methods are provided for detecting and mitigating jamming attacks in LPWAN environments, particularly LoRaWAN networks. In one aspect, machine learning algorithms are used, and more particularly in Long Short-Term Memory (LSTM) neural networks, to distinguish malicious jamming from normal network congestion by analyzing network performance metrics, including packet loss ratios and received signal strength indicators over time.

The system collects comprehensive network performance data including timestamps, spreading factors, frequencies, frame counters, and device identifiers. This data is processed through a machine learning pipeline that normalizes the data and analyzes temporal patterns to identify anomalous behavior indicative of jamming attacks.

In another aspect, the invention implements an automated cloud-based mitigation framework that coordinates the network response to detected jamming. Upon detection, the system initiates a sequence of actions including random channel selection, configuration updates via MQTT messaging, and coordinated transition of sensor nodes to new frequency bands. This mitigation approach leverages cloud services for alert distribution, processing coordination, model hosting, and data storage.

The invention takes advantage of LoRaWAN's inherent “Capture Effect” characteristics while providing additional protection against sophisticated jamming attempts. When two non-orthogonal packets arrive simultaneously, the system can still successfully receive packets with sufficient signal strength differential, providing natural interference resistance that complements the active detection and mitigation features.

Systems configured in accordance with aspects of the invention may achieve high accuracy in jamming detection while maintaining a low false positive rate, enabling reliable operation in real-world environments. The system's architecture supports continuous monitoring and dynamic adjustment of operating parameters to maintain network integrity in the face of evolving jamming threats.

### BRIEF DESCRIPTION OF THE DRAWINGS

The numerous advantages of the present invention may be better understood by those skilled in the art by reference to the accompanying drawings in which:

FIG. 1 shows a channel density plot comparing network traffic patterns under normal operation versus jamming conditions.

FIG. 2 shows performance metrics of the LSTM model including precision, recall, f1-score and support values for jamming detection.

FIG. 3 shows a graph of LSTM packet loss analysis with detected anomalies plotted over time.

FIG. 4 shows a confusion matrix demonstrating the LSTM model's classification performance for normal versus anomalous network conditions.

FIG. 5 shows a distribution plot of the mean average error (MAE) used for determining anomaly thresholds in the training data.

FIG. 6 shows a system architecture diagram illustrating the data flow between the LoRaWAN gateway, AWS services, and processing components for jamming detection and mitigation.

FIG. 7 shows a flowchart depicting the sequence of operations performed by the network server when implementing jamming mitigation procedures, including configuration updates and frequency transitions.

### DETAILED DESCRIPTION

The invention summarized above may be better understood by referring to the following description, claims, and accompanying drawings. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

Descriptions of well-known functions and structures are omitted to enhance clarity and conciseness. The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced items.

The use of the terms “first”, “second”, and the like does not imply any particular order, but they are included to identify individual elements. Moreover, the use of the terms first, second, etc. does not denote any order of importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although some features may be described with respect to individual exemplary embodiments, aspects need not be limited thereto such that features from one or more exemplary embodiments may be combinable with other features from one or more exemplary embodiments.

Computer readable program instructions described herein can be downloaded to respective computing/processing devices from a computer readable storage medium or to an external computer or external storage device via a network, such as for example the Internet, a local area network, a wide area network and/or a wireless network. The network may comprise copper transmission cables, optical transmission fibers, wireless transmission, routers, firewalls, switches, gateway computers and/or edge servers.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server.

Low-power wide-area networks (LPWAN) enable Internet of Things applications by providing long-range communication with small data payloads and extended battery life. These networks are particularly vulnerable to jamming attacks at their physical and MAC layers, despite implementing security measures at higher protocol layers. Systems and methods configured in accordance with certain aspects of the present invention provide detect such attacks using machine learning techniques and implement automated mitigation responses through cloud-based services.

In accordance with certain aspects of an embodiment, the system continuously monitors network performance metrics to identify anomalous patterns indicative of jamming. Upon detection, the system executes a coordinated response to transition affected nodes to new operating frequencies while maintaining network integrity. The system leverages the inherent “Capture Effect” characteristics of LoRaWAN, where packets with sufficient signal strength differential can still be successfully received despite interference, while adding sophisticated detection and active mitigation capabilities.

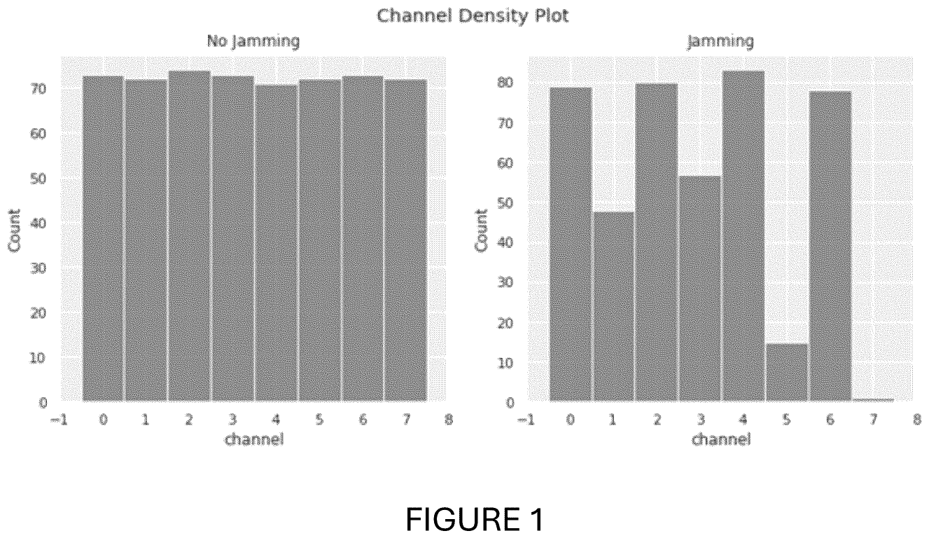

The machine learning model processes network performance metrics through several key stages to identify jamming patterns. FIG. 1 shows a channel density plot illustrating distinct patterns of network traffic under normal operation versus jamming conditions, demonstrating how jamming attacks create measurable disruptions that can be detected by the system.

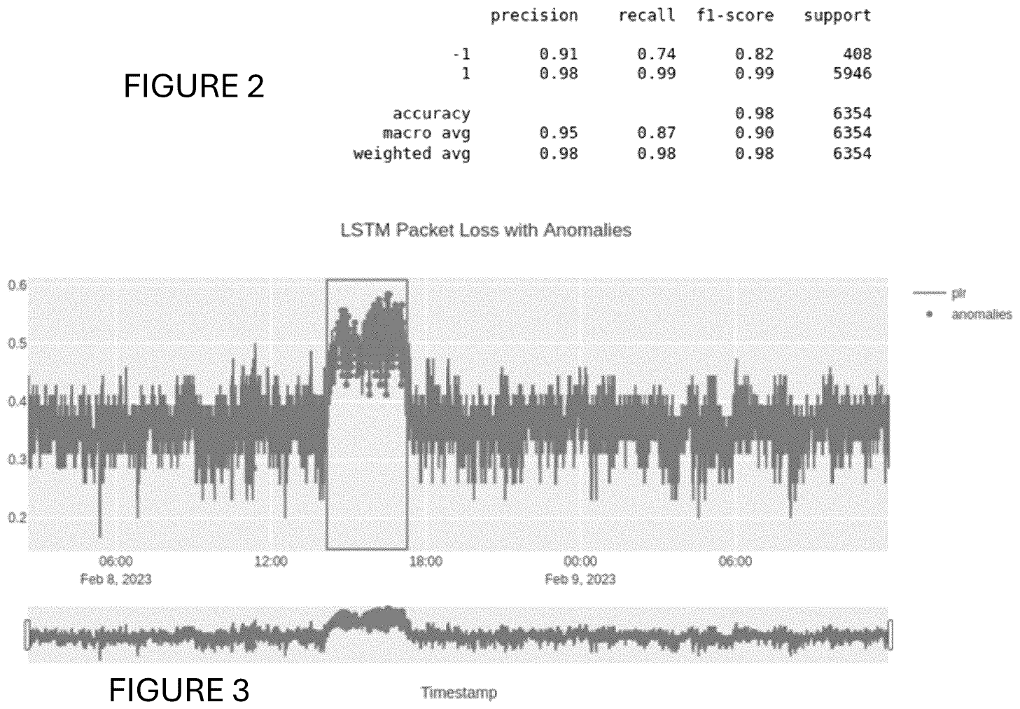

The system's machine learning implementation achieves robust performance in detecting these jamming patterns. FIG. 2 shows the performance metrics of the LSTM neural network model, including precision, recall, f1-score and support values, demonstrating 98% overall accuracy in jamming detection, with 91% precision in anomaly detection.

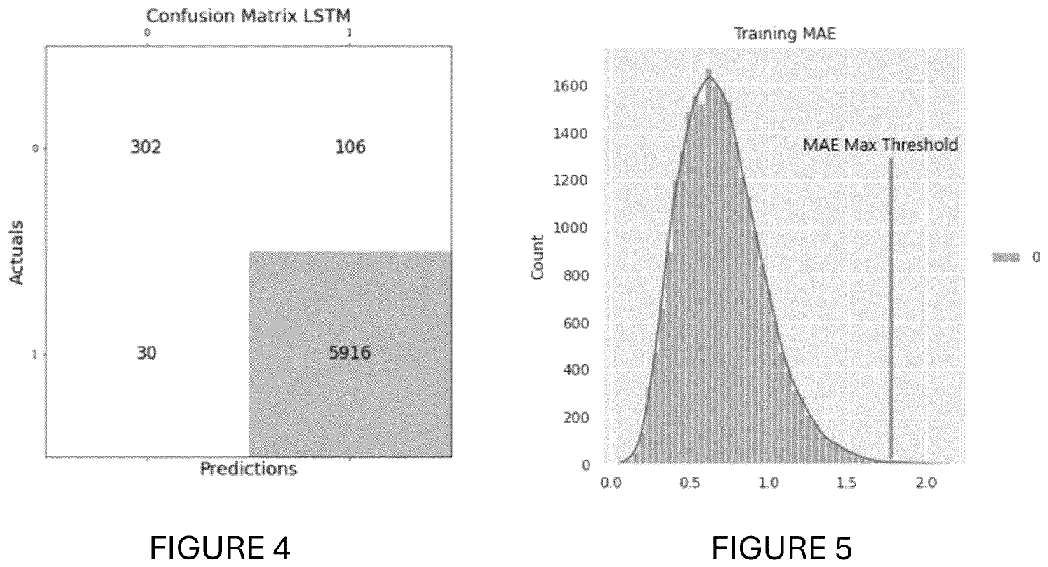

The temporal analysis capabilities are likewise illustrated in FIG. 3, which plots LSTM packet loss analysis with detected anomalies over time, showing how the system distinguishes between normal network congestion and coordinated jamming attempts. FIG. 4 presents a confusion matrix validating the model's classification performance, showing correct prediction of 74% of anomalies while maintaining a 0.5% false positive rate.

The system establishes appropriate thresholds for anomaly detection through careful analysis of training data. FIG. 5 shows the distribution plot of mean average error (MAE), which guides the selection of operational thresholds that balance detection sensitivity with false positive prevention.

In accordance with certain aspects of an embodiment of the invention, an exemplary system was deployed that includes a LoRaWAN testbed network operating in a cloud environment using a Raspberry Pi 4 running chirpstack Network and Application servers. The network hardware configuration consisted of a RAK7246 Pi HAT LPWAN Concentrator module combined with a Raspberry Pi Zero W kit functioning as the gateway. The sensor nodes were constructed using Arduino MKR WAN 1310 microcontrollers equipped with Grove BME280 temperature and pressure sensors. These nodes utilize Murata CMWX1ZZABZ LoRa modules operating at 915 MHz for radio communication. While this hardware configuration represents one exemplary implementation, those skilled in the art will recognize that other compatible hardware components may be utilized.

Using the Arduino IDE, the sensor nodes were programmed to capture environmental data and transmit it over the LoRa radio to the gateway. The gateway forwarded these messages to the network servers running on the Raspberry Pi. The system then published this data to Amazon's AWS IoT cloud service from the LoRa application server using MQTT protocol.

In the exemplary implementation, four jammers were constructed using Arduino Uno microcontrollers, Adafruit LoRa RFM95 modules, and 915 MHz antennas. The jammers were programmed using the RadioLib library to sense and transmit at four of the eight uplink frequencies in the LoRaWAN network. This configuration allowed for generating measurable packet loss by jamming half of the available uplink frequencies. Alternative jammer configurations may be used for testing purposes.

LoRaWAN employs the “Capture Effect” phenomenon to handle packet collisions. When two non-orthogonal packets arrive simultaneously at the gateway, a collision typically occurs resulting in loss of both packets. However, if one packet's received power exceeds the other by six dB or more, the network will successfully receive the stronger signal. While this provides some natural interference resistance, dedicated jamming attacks can still overcome this protection.

The exemplary system collected comprehensive network performance data including timestamps, spreading factors, frequencies, frame counter values, temperature and humidity readings, and device identifiers. In one implementation, this comprised over 31,900 samples collected across seven days of network operation. The system specifically focused on uplink communication from end devices to the gateway, using the Received Strength Signal Indicator (RSSI) and packet loss ratio (PLR) as key features for model training.

The jamming detection system according to certain aspects of the invention employs a Long Short-Term Memory (LSTM) neural network model implemented, for example, using TensorFlow and Keras libraries. In the exemplary implementation, the model was developed using an Anaconda distribution Python 3 Jupyter notebook. The collected data undergoes preprocessing through several steps. First, the data is loaded into Pandas dataframes and the packet loss ratio is calculated using frame counter values. The dataset is then split using an 80-20 ratio, with 80% used for training under normal operating conditions and 20% reserved for testing with jamming anomalies. The Sklearn standard scaler function normalizes the data to unit variance with zero mean.

The LSTM network processes data shaped as three-dimensional tensors containing data samples, time steps, and features, with an input sequence size of 10 steps used for prediction. The model undergoes training for 50 epochs to achieve optimal performance. While these specific parameters were found effective in testing, those skilled in the art may adjust these values based on specific implementation requirements.

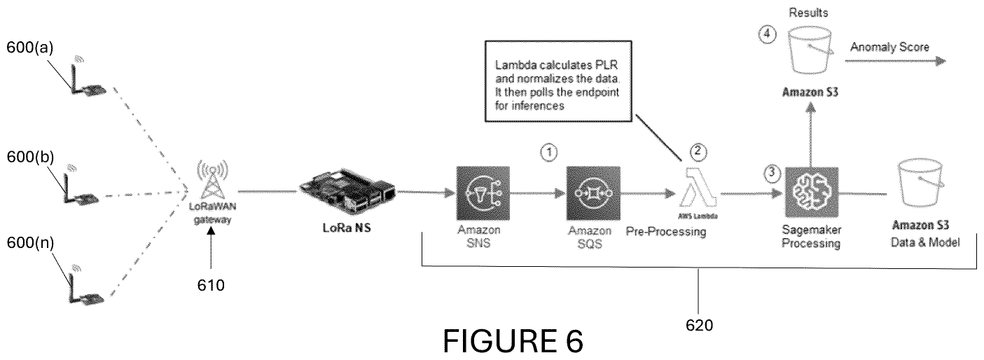

Next and as shown in the system architecture diagram of FIG. 6, which depicts data flow between the LoRaWAN gateway, cloud computing services (such as AWS services), and processing components for jamming detection and mitigation, the LoRaWAN gateway 610 collects data from sensor nodes 600(a)-600(n) and forwards it through AWS services 620 including SNS for alert distribution, Lambda for data processing, SageMaker for model hosting, and S3 for storage.

Upon detecting jamming conditions, the system implements an automated response through, for example, AWS cloud services following a specific sequence. First, the network server transmits data to AWS using the Simple Notification Service. Lambda functions then process this data by extracting RSSI and frame counter information and calculating packet loss ratios. The Lambda functions invoke a SageMaker model endpoint, with results stored in S3 storage.

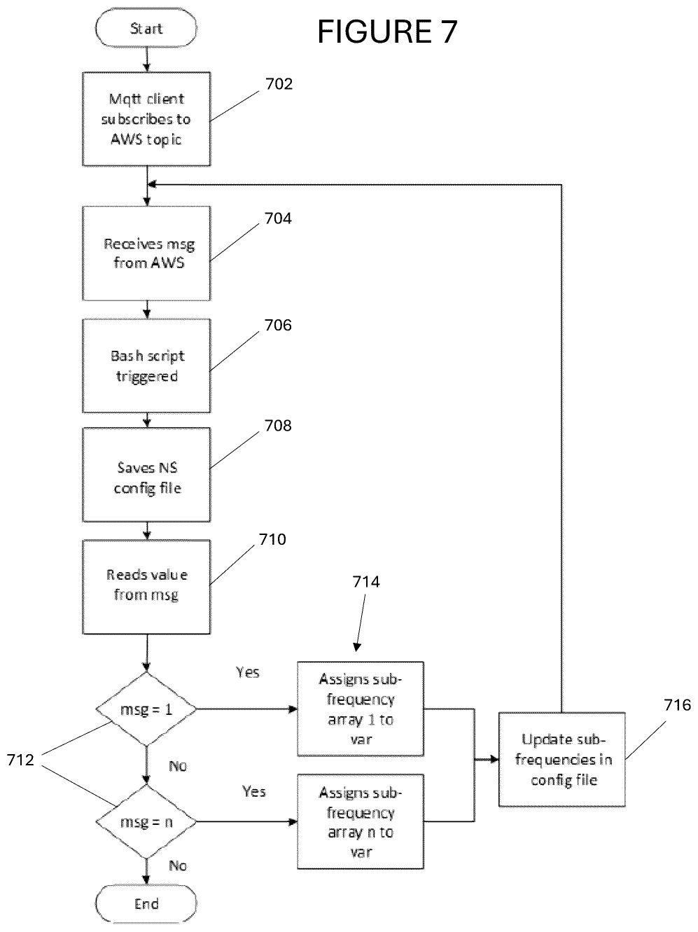

When jamming is detected, the system executes a coordinated mitigation response as the output score passes from the S3 bucket to an AWS Lambda for post-processing. As shown in FIG. 7, the network server follows a specific sequence of operations starting with the MQTT client subscribing to the MQTT topic (e.g., using Python code) to receive messages from AWS at step 702. The system generates a random number between zero and nine, which determines the new frequency selection. This number is published to an MQTT topic, with the LoRaWAN network server configured as the message destination.

When the message is received from AWS at step 704, this triggers a bash script to execute at step 706. The bash script first saves a copy of the network server configuration file at step 708 to preserve the current settings. The script then reads the value contained in the received message at step 710 and associates it with a new sub-band. More particularly, at step 712, if the message value equals 1, the script assigns at step 714 sub-frequency array 1 to a variable. If the message value equals some other value n, the script assigns at step 714 sub-frequency array n to the variable. If neither condition is met, the process ends.

After assigning the appropriate sub-frequency array, the script updates the sub-frequencies in the network server configuration file at step 716 with the new operating frequency values. This implements the frequency changes needed to mitigate the detected jamming while maintaining network operation. The process then concludes, having successfully updated the network configuration to avoid the jammed frequencies.

While this process represents one implementation of the mitigation sequence, those skilled in the art may modify these steps based on specific deployment requirements while maintaining the core functionality.

This automated sequence enables rapid response to jamming detection while ensuring controlled and coordinated transition of the network to new operating frequencies. The preservation of configuration files and structured update process helps maintain network stability during the mitigation response.

The system's effectiveness was validated through extensive testing using a dataset of over 31,900 samples collected across seven days of network operation. The testing environment included four jammers constructed with Arduino Uno microcontrollers and Adafruit LoRa RFM95 modules, programmed to interfere with four of the eight uplink frequencies in the LoRaWAN network.

As noted above with respect to FIG. 2, the LSTM model demonstrated robust performance in detecting jamming attacks, achieving an overall accuracy of 98% as measured by the weighted average f1-score. Detailed performance metrics show 91% precision in anomaly detection and a 74% recall rate for identifying jamming incidents. Notably, the system maintained a low false positive rate of 0.5%, with only 30 non-anomalous points misclassified as anomalies out of 5,946 normal data points.

The confusion matrix analysis of FIG. 4 shows that the model correctly predicted 74% of the 408 anomalies, missing 106 instances, while correctly classifying 5,916 out of 5,946 normal operating conditions. This high accuracy in classifying normal operations while maintaining sensitivity to jamming events demonstrates the system's practical effectiveness for real-world deployment.

The model's performance was validated using an 80-20 dataset split, with 80% of data used for training under normal operating conditions and the remaining 20% reserved for testing with jamming anomalies. As noted above with respect to FIG. 5, the mean average error (MAE) distribution from the training set was used to establish appropriate thresholds for anomaly detection in operational deployment.

Systems and methods configured in accordance with aspects of the invention may provide several key technical improvements over existing jamming detection and mitigation approaches. While prior systems often rely on basic signal strength thresholds or simple alarm mechanisms that struggle to differentiate sophisticated jamming from normal network congestion, systems and methods according to the invention employ machine learning techniques to achieve significantly higher detection accuracy. Specifically, the system demonstrates 98% overall accuracy in jamming detection through its LSTM neural network implementation, with 91% precision in identifying anomalies and only a 0.5% false positive rate. This represents a substantial improvement over conventional threshold-based approaches that cannot effectively distinguish between malicious jamming and routine network interference.

The automated mitigation framework described herein provides advantages over existing manual intervention approaches. While prior systems typically require human response to potential jamming, systems configured as described herein implement immediate automated frequency transitions through cloud-based services, maintaining network continuity. The integration with cloud services enables sophisticated data processing and real-time response capabilities while preserving the power efficiency benefits critical for LPWAN applications.

Unlike previous blockchain-based solutions that introduce significant computational overhead, systems according to aspects of the invention maintain the low-power characteristics essential for LPWAN operation. Such systems leverage LoRaWAN's inherent “Capture Effect” while adding sophisticated detection and active mitigation capabilities that overcome the limitations of relying solely on signal strength differentials for interference resistance.

The system's ability to collect and analyze comprehensive network performance data, including timestamps, spreading factors, frequencies, and frame counters, enables more nuanced detection than prior approaches focused on single metrics. This multi-factor analysis, combined with temporal pattern recognition through the LSTM model, provides superior discrimination between legitimate network conditions and malicious jamming attempts.

Moreover, systems and methods configured in accordance with aspects of the invention may have numerous industrial applications and commercial advantages. For example, such systems enable reliable monitoring of industrial equipment and production lines through protected sensor networks. The high detection accuracy and low false positive rate of 0.5% ensures continuous operation monitoring while minimizing disruptions to manufacturing processes. The system's ability to maintain network integrity is particularly valuable for automated production environments where sensor data drives critical operational decisions.

Likewise, in healthcare facilities, such systems may protect vital patient monitoring networks and medical device communications from interference. The robust jamming protection ensures continuous operation of sensors tracking patient vital signs, equipment status, and environmental conditions. The cloud-based architecture enables secure remote monitoring while maintaining HIPAA-compliant data handling.

Further, for urban deployments, such systems may protect critical infrastructure monitoring including, e.g., traffic control systems, public transportation networks, emergency response communications, environmental monitoring stations, and smart utility meters. The automated mitigation capabilities are especially valuable for maintaining continuous operation of city-wide sensor networks that support essential public services.

Still further, such systems may enable reliable tracking of inventory movement, environmental conditions, and equipment status across large-scale warehouse operations. The low false positive rate ensures minimal disruption to automated logistics systems while maintaining security against interference.

Even further, the sophisticated jamming detection capabilities described herein may help prevent meter fraud and data falsification in utility networks. The high detection accuracy and automated mitigation features are particularly valuable for utilities that rely on continuous monitoring of distributed infrastructure for power, water, and gas delivery systems.

Still further, in agricultural settings, such systems may protect sensor networks monitoring soil conditions, livestock, weather conditions, and automated irrigation systems. The robust jamming protection ensures continuous operation of sensors tracking feeding issues, reproductive cycles, and location tracking of animals.

The cloud-based architecture employed by systems and methods described herein provides significant commercial advantages across all of these sectors by enabling remote monitoring and control capabilities. Facility owners and operators can monitor situations remotely and implement corrective actions from any location, addressing a key limitation of conventional sensor networks that require local access.

While the foregoing detailed description presents specific implementations using LSTM neural networks, the jamming detection system and methods described herein may employ other machine learning approaches that can effectively analyze temporal patterns in network performance data. The key requirements are the ability to process time-series data and identify anomalous patterns indicative of jamming attacks while maintaining the system's demonstrated performance metrics.

The cloud-based mitigation framework, while described using AWS services, may be implemented using comparable cloud service providers and technologies that offer similar capabilities for message notification and queuing, serverless computing functions, machine learning model hosting, and data storage and retrieval. The frequency selection process during mitigation may employ various approaches beyond simple random selection, provided they maintain unpredictability in channel assignments while avoiding recently jammed frequencies. However, any alternative selection method should preserve the system's ability to quickly transition the network to new operating parameters.

The network architecture may utilize different hardware components for the gateway and sensor nodes, provided they support the required LoRaWAN protocols and maintain compatibility with the chirpstack Network and Application server implementation. The specific choice of microcontrollers, radio modules, and sensors may be modified based on deployment requirements while preserving the core functionality of the jamming detection and mitigation system.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention may be practiced otherwise than as specifically set forth herein.

1. A method for detecting and mitigating jamming in a low-power wide-area network (LPWAN), comprising:
receiving network performance data from a plurality of sensor nodes, wherein the network performance data comprises packet loss ratios and received signal strength indicators;
analyzing temporal patterns in the network performance data using a machine learning model to distinguish between malicious jamming and normal network congestion;
upon detecting a jamming condition, automatically initiating mitigation procedures comprising random channel selection; and
coordinating transition of the sensor nodes to new frequency bands.

2. The method of claim 1, wherein the network performance data comprises:
packet loss ratio (PLR);
received signal strength indicator (RSSI);
frame counter sequences; and
channel utilization patterns.

3. The method of claim 1, wherein the machine learning model comprises a Long Short-Term Memory (LSTM) neural network trained on historical network performance data.

4. The method of claim 1, wherein automatically initiating mitigation procedures comprises:
generating a random channel selection;
updating network server configurations; and
coordinating transition of sensor nodes to new frequency bands.

5. The method of claim 1, wherein the LPWAN comprises a LoRaWAN network operating in sub-GHz ISM bands using Chirp Spread Spectrum modulation.

6. The method of claim 1, wherein analyzing the network performance data using a machine learning model comprises:
loading collected data into dataframes;
calculating packet loss ratios using frame counter values;
normalizing the data using a standard scaler to unit variance with zero mean; and
processing the normalized data through a Long Short-Term Memory (LSTM) neural network.

7. The method of claim 6, wherein processing the normalized data through the LSTM neural network comprises:
shaping input data as three-dimensional tensors containing data samples, time steps, and features;
using an input sequence size of 10 steps for prediction; and
training the network for 50 epochs.

8. The method of claim 1, wherein automatically initiating mitigation procedures comprises:
transmitting data to a cloud service using a notification service;
processing the data using serverless functions to extract signal strength and frame counter information;
invoking a machine learning model endpoint; and
storing results in cloud storage.

9. The method of claim 8, wherein modifying network operating parameters comprises:
generating a random number between zero and nine;
publishing the number to a messaging topic;
updating network server configuration files with new operating frequencies based on the random number; and
rebooting the network server to implement the frequency changes.

10. The method of claim 8, wherein the cloud service comprises:
a notification service for distributing alerts;
serverless computing functions for response coordination;
a machine learning platform for model hosting; and
object storage for data persistence.

11. A system for detecting and mitigating jamming in a LPWAN, comprising:
a plurality of sensor nodes configured to generate network performance data comprising packet loss ratios and received signal strength indicators;
a network gateway configured to collect the network performance data from the sensor nodes;
a machine learning model configured to analyze temporal patterns in the network performance data to distinguish between malicious jamming and normal network congestion; and
a mitigation controller configured to implement random channel selection and coordinate transition of the sensor nodes to new frequency bands in response to detected jamming.

12. The system of claim 11, wherein the machine learning model is trained on a dataset comprising:
normal operating condition data; and
intentionally induced jamming scenario data.

13. The system of claim 11, wherein the mitigation controller utilizes cloud services for:
alert distribution;
processing coordination;
model hosting; and
data storage.

14. The system of claim 11, wherein the machine learning model is configured to:
load collected data into dataframes;
calculate packet loss ratios using frame counter values;
normalize the data using a standard scaler to unit variance with zero mean; and
process the normalized data through a Long Short-Term Memory (LSTM) neural network.

15. The system of claim 11, wherein the network performance data comprises:
timestamps;
spreading factors;
frequencies;
frame counter values;
temperature readings; and
device identifiers.

16. The system of claim 11, wherein the mitigation controller is further configured to:
transmit data to cloud services using a notification service;
process the data using serverless functions;
invoke machine learning model endpoints; and
store results in cloud storage.

17. A cloud-based jamming mitigation system, comprising:
notification services configured to receive network performance data comprising packet loss ratios and received signal strength indicators;
processing functions configured to analyze temporal patterns in the network performance data to distinguish between malicious jamming and normal network congestion;
model hosting services configured to execute machine learning models for jamming detection; and
mitigation services configured to implement random channel selection and coordinate transition of sensor nodes to new frequency bands.

18. The system of claim 17, wherein the processing functions are configured to:
extract network performance metrics;
calculate packet loss ratios;
invoke model endpoints; and
coordinate mitigation responses.

19. The system of claim 17, further comprising message queuing services configured to:
receive model outputs;
generate random channel selections; and
publish configuration updates.

20. The system of claim 17, wherein mitigation responses include:
saving current configurations;
updating operating frequencies;
rebooting network servers; and
confirming successful transitions.
